(19) United States
(12) Patent Application Publication
(10) Pub. No.: US 2013/0316568 A1
(43) Pub. Date: Nov. 28, 2013

(54) ELECTRICAL CONNECTOR WITH FASTENING MEMBER FASTENED TO POWER CONTACT

(71) Applicants: Wang-I YU, JHONGHE (TW); Yong-Gang ZHANG, Taicang (CN)

(72) Inventors: Wang-I YU, JHONGHE (TW); Yong-Gang ZHANG, Taicang (CN)

(73) Assignee: ALLTOP ELECTRONICS (SUZHOU) LTD., Taicang City (CN)

(21) Appl. No.: 13/553,459

(22) Filed: Jul. 19, 2012

(30) Foreign Application Priority Data
May 25, 2012 (CN) 201210166047.6

(51) Int. Cl. H01R 4/70

(52) U.S. Cl. 439/485

(57) ABSTRACT

An electrical connector (100) includes an insulative housing (10), a number of first contacts (21) and second contacts (22) retained in the insulative housing and a metallic shell (40) enclosing the insulative housing. Each first contact (21) includes a resilient first contacting portion (212) and each second contact (22) includes a flat second contacting portion (222) located at a front of the resilient first contacting portions. The metallic shell includes a number of peripheral walls jointly forming a receiving cavity (410) for receiving a mateable connector. At least one of the peripheral walls includes a heat dissipation slot (431) in communication with the receiving cavity (410) and a heat dissipation piece (47) attached to the heat dissipation slot (431) so that heat generated from the first contacts (21) and the second contacts (22) can be immediately emitted by the heat dissipation piece (47).

### BACKGROUND OF THE INVENTION

1. Field of the Invention

The present invention relates to an electrical connector, and more particularly to an electrical connector mounted on a PCB and with robust heat dissipation effect.

2. Description of Related Art

With rapid development of electronic technologies, electrical connectors need to meet high-speed signal transmission requirements. USB (Universal Serial Bus) 3.0 connectors are those currently fashionable I/O (Input/Output) ports used in high-ranking electronic devices. The USB 3.0 connectors are compatible to USB 2.0 versions. Besides, comparing with the USB 2.0 connectors, the USB 3.0 connectors add two pairs of differential contacts and a grounding contact therebetween. Although the USB 3.0 connectors are capable of meeting high-speed signal transmission, heat dissipation problems thereof are big issues to those of ordinary skill in the art. In order to solve these problems, thermal adhesive is usually attached to the USB 3.0 connectors so as to meet safety requirements. However, such solution has poor reliability, and the characteristic of the thermal adhesive itself may result in the USB 3.0 connectors easy to loose efficacy.

Hence, it is desirable to provide an improved electrical connector with robust heat dissipation effect for solving the above problems.

### BRIEF SUMMARY OF THE INVENTION

The present invention provides an electrical connector including an insulative housing, a plurality of first contacts and a plurality of second contacts retained in the insulative housing, and a metallic shell enclosing the insulative housing. The insulative housing includes a main body and a mating tongue extending forwardly from the main body. The mating tongue defines a mating surface. Each first contact includes a resilient first contacting portion upwardly extending beyond the mating surface. Each second contact includes a flat second contacting portion exposed to the mating surface. The flat second contacting portions are located at a front of the resilient first contacting portions. The metallic shell includes a plurality of peripheral walls jointly forming a receiving cavity in which the mating tongue resides. At least one of the peripheral walls includes a heat dissipation slot in communication with the receiving cavity and a heat dissipation piece attached to the heat dissipation slot. The heat dissipation piece is separatedly made from the metallic shell and then fixed to the metallic shell. As a result, heat generated from the first contacts and the second contacts can be transmitted to and emitted by the heat dissipation piece so as to achieve robust heat dissipation.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of an electrical connector in accordance with an illustrated embodiment of the present invention;

FIG. 2 is an exploded view of the electrical connector as shown in FIG. 1;

FIG. 3 is a perspective view of an insulative housing of the electrical connector as shown in FIG. 2;

FIG. 4 is another perspective view of the insulative housing taken from another aspect;

FIG. 5 is a perspective view of the contacts of the electrical connector;

FIG. 6 is a perspective view of the insulative housing with the contacts mounted therein;

FIG. 7 is a perspective view of a contact organizer of the electrical connector; and

FIG. 8 is a perspective view of a metal shell of the electrical connector.

### DETAILED DESCRIPTION OF THE PREFERRED EMBODIMENT

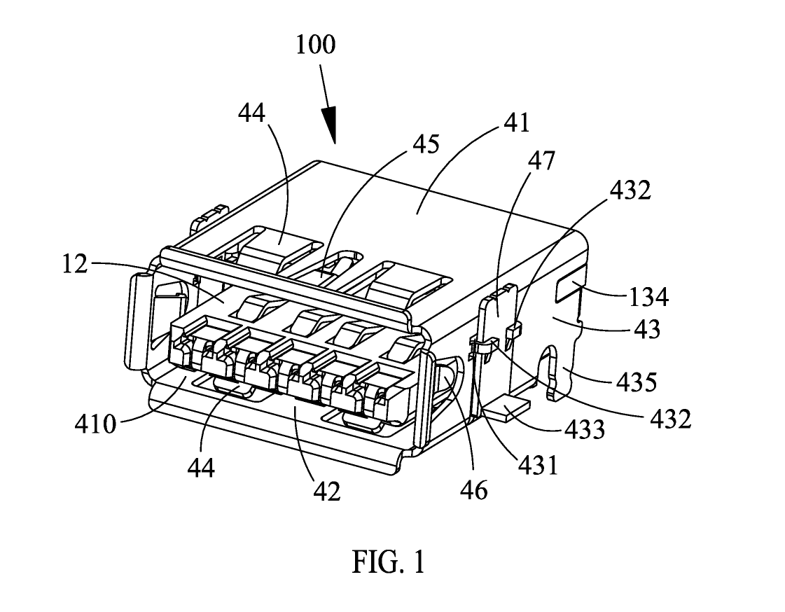

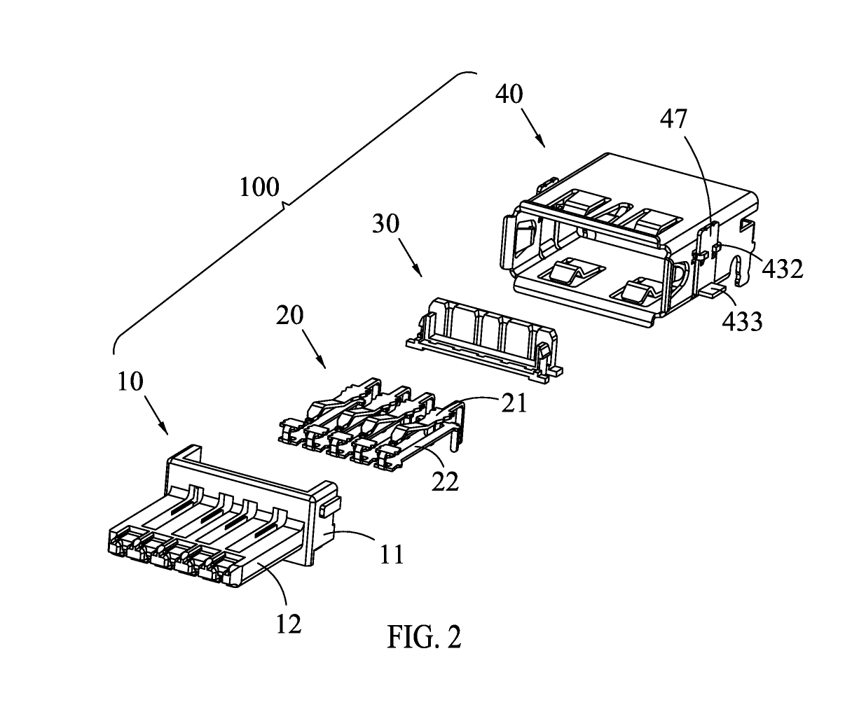

Reference will now be made to the drawing figures to describe the preferred embodiment of the present invention in detail. As shown in FIGS. 1 to 2, the illustrated embodiment of the present invention discloses an electrical connector 100 including an insulative housing 10, a plurality of contacts 20 retained in the insulative housing 10, a contact organizer 30 fixed to the rear end of the insulative housing 10 for regulating the contacts 20, and a metallic shell 40 enclosing the insulative housing 10. According to the illustrated embodiment of the present invention, the electrical connector 100 is a USB connector compatible to USB 3.0 standard.

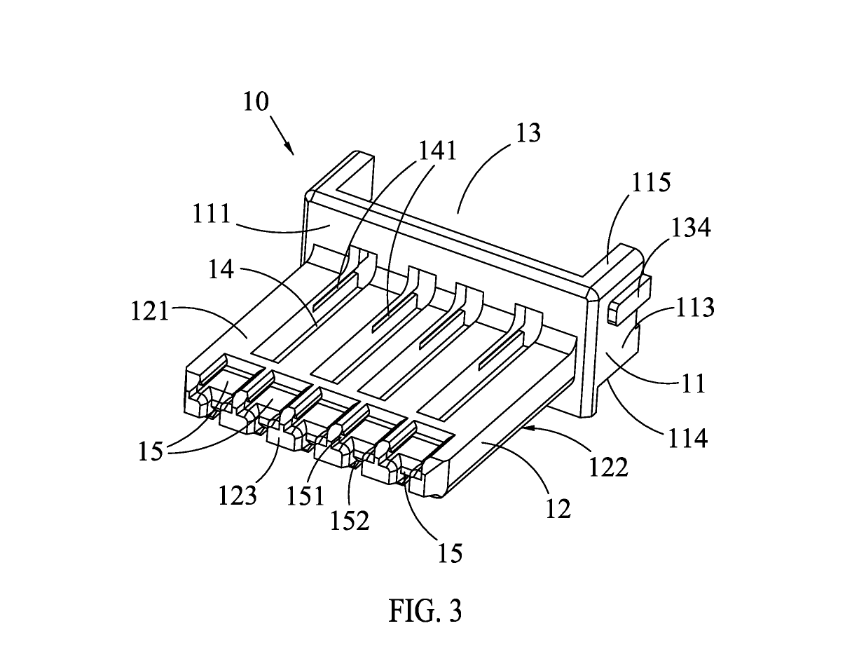

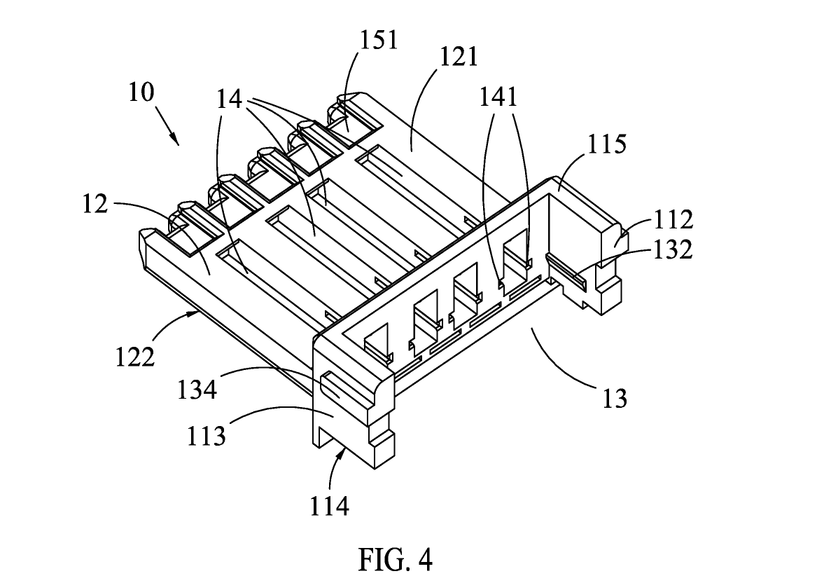

Referring to FIGS. 3 and 4, the insulative housing 10 includes a main body 11 and a mating tongue 12 extending forwardly from the main body 11. The main body 11 defines a front surface 111, a back surface 112 (as shown in FIG. 4) opposite to the front surface 111, a top surface 115, a bottom surface 114 opposite to the top surface 115 and a pair of side surfaces 113 located between the front surface 111 and the back surface 112 along a front-to-back direction. The main body 11 defines a rear cavity 13 vertically extending through the top surface 115 and the bottom surface 114. The rear cavity 13 extends inwardly into the main body 11 for receiving the contact organizer 30. Besides, referring to FIG. 4, the main body 11 includes a pair of locking blocks 132 (only one of them is shown) sidewardly protruding into the rear cavity 13. Furthermore, the main body 11 includes a pair of positioning blocks 134 protruding outwardly from the pair of side surfaces 113.

As shown in FIGS. 3 and 4, the mating tongue 12 includes a mating surface 121, a bottom surface 122 opposite to the mating surface 121 and a front surface 123 at a distal end thereof. A plurality of first slots 14 are formed through the mating surface 121 and further backwardly in communication with the rear cavity 13. The insulative housing 10 includes a plurality of narrow slots 141 in communication with corresponding first slots 14. Besides, a plurality of second slots 15 are defined through the front surface 123 of the insulative housing 10. As shown in FIG. 3, each second slot 15 includes an upper slot 151 and a lower slot 152 overlapping along a vertical direction. The first slots 14 and the second slots 15 are offset from each other along the front-to-back direction and are arranged in two rows along the vertical direction.

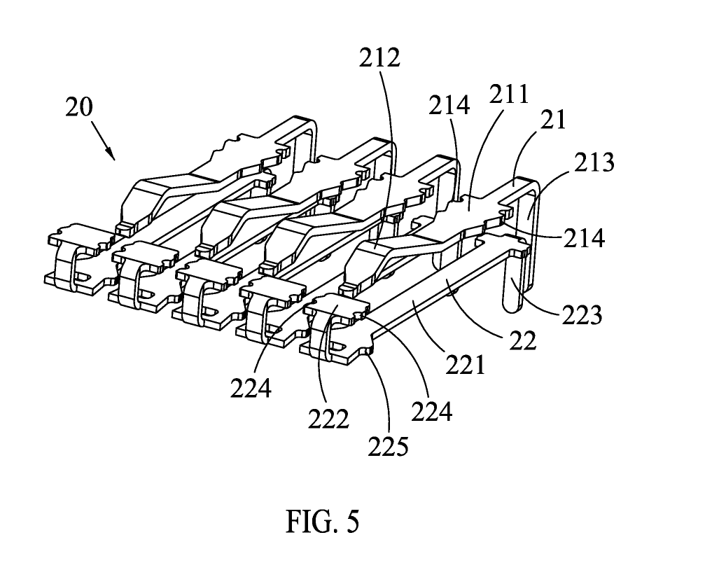

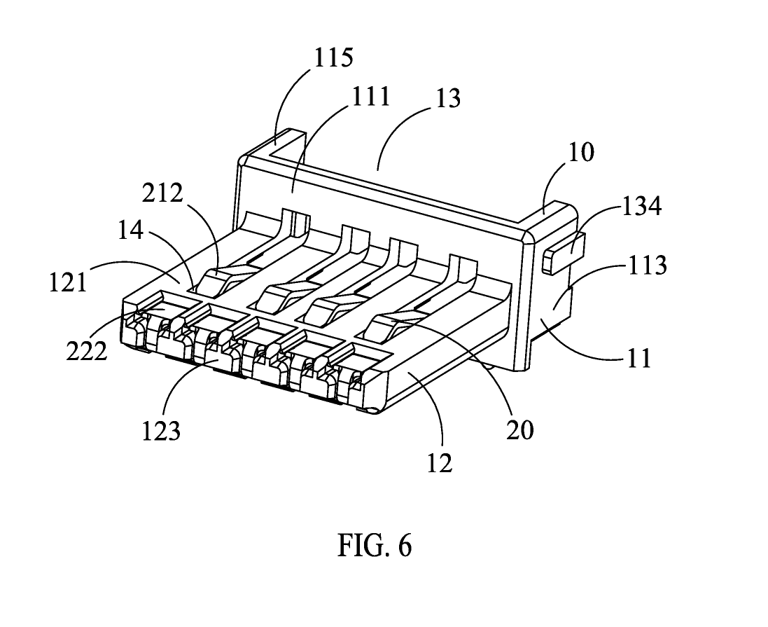

Referring to FIGS. 5 and 6, the contacts 20 include a plurality of first contacts 21 received in the first slots 14 and a plurality of second contacts 22 received in the second slots 15. Either the first contacts 21 or the second contacts 22 include a grounding contact and at least one pair of differential contacts. Each first contact 21 includes a first retaining portion 211, a resilient first contacting portion 212 extending from the first retaining portion 211 and a first soldering portion 213 perpendicularly bent from the first retaining portion 211. The first retaining portion 211 includes a plurality of barbs 214 for engaging with the narrow slots 141 for fixation when the first contacts 21 are inserted into the first slots 14 along a back-to-front direction. As shown in FIG. 6, the resilient first contacting portions 212 extend beyond the mating surface 121 and are deformable in the corresponding first slots 14 along the vertical direction.

Each second contact 22 includes a second retaining portion 221, a flat/rigid second contacting portion 222 bent upwardly and backwardly from the second retaining portion 221 and a second soldering portion 223 perpendicularly bent from the second retaining portion 221. The second contacting portion 222 is parallel to the second retaining portion 221. Each second contacting portion 222 includes a plurality of first barbs 224 engaged within the upper slots 151 for fixation. Each second retaining portion 221 includes a plurality of second barbs 225 engaged with the lower slots 152 for fixation as well. As shown in FIG. 6, the second contacting portions 222 are located at a front of the first contacting portions 212 along the front-to-back direction.

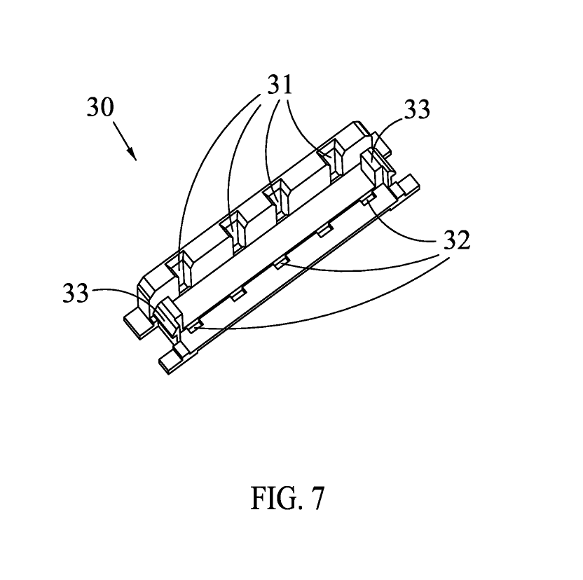

Referring to FIG. 7, the contact organizer 30 is fastened into the rear cavity 13 along a bottom-to-top direction. The contact organizer 30 includes a plurality of first holes 31 through which the first soldering portions 213 extend, a plurality of second holes 32 through which the second soldering portions 223 extend and a pair of latches 33 for locking with the locking blocks 132 of the insulative housing 10. As a result, the first soldering portions 213 and the second soldering portions 223 are well regulated before being mounted to a PCB (not shown).

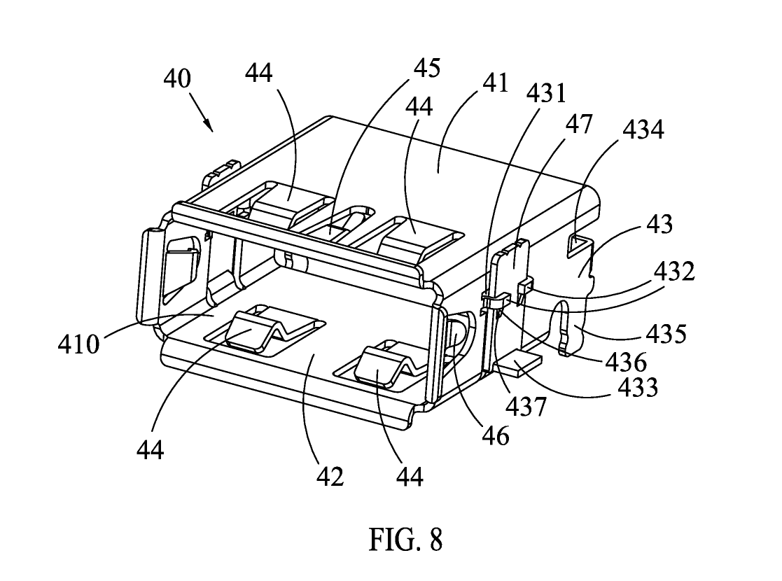

As shown in FIG. 8, the metallic shell 40 includes a plurality of peripheral walls including a top wall 41, a bottom wall 42 opposite to the top wall 41 and a pair of side walls 43 connecting the top wall 41 and the bottom wall 42. The top wall 41, the bottom wall 42 and the pair of side walls 43 jointly form a receiving cavity 410 in which the mating tongue 12 resides (as shown in FIG. 1). Each of the top wall 41 and the bottom wall 42 includes a pair of locking arms 44 extending along the back-to-front direction for locking with a mateable connector (not shown). Besides, the top wall 41 includes a first engaging arm 45 extending along the front-to-back direction for engaging with the mateable connector so as to improve friction force therebetween. Each side wall 43 includes a second engaging arm 46 extending along the front-to-back direction for engaging with the mateable connector so as to improve friction force therebetween as well. Under the function of the locking arms 44, the first engaging arm 45 and the second engaging arms 46, when the mateable connector is inserted into the receiving cavity 410, it can be securely held therein. Besides, each side wall 43 defines a rear positioning slot 434 for mating with the positioning blocks 134 of the insulative housing 10 as shown in FIG. 1. Furthermore, each side wall 43 includes a mounting leg 435 extending downwardly for being soldered to the PCB.

Referring to FIG. 8, according to the illustrated embodiment of the present invention, each side wall 43 includes a heat dissipation slot 431 in communication with the receiving cavity 410, an outward locking member (not labeled) corresponding to the heat dissipation slot 431, and a supporting portion 433 extending horizontally and outwardly adjacent to and essentially coplanar with the bottom wall 42. According to the illustrated embodiment of the present invention, the locking member includes a pair of L-shaped locking protrusions 432 which are stamped outwardly from the heat dissipation slot 431. The pair of locking protrusions 432 face each other and form a receiving slot (not shown) therebetween.

Most importantly, each side wall 43 is equipped with a heat dissipation member corresponding to the heat dissipation slot 431. According to the illustrated embodiment of the present invention, the heat dissipation member is a heat dissipation piece 47 attached to the heat dissipation slot 431 so that heat generated from the first contacts 21 and the second contacts 22 can be transmitted to the heat dissipation piece 47 for dissipating heat immediately. As a result, the integral heat dissipation capability of the electrical connector 100 is well improved. Under this condition, the electrical connector 100 can meet safety requirements and pass safety certifications.

As shown in FIG. 8, the heat dissipation piece 47 is essentially of rectangular shape. The heat dissipation piece 47 is separatedly made from the metallic shell 40 and then fixed to the metallic shell 40. Under this arrangement, materials of the heat dissipation piece 47 and the metallic shell 40 can be different. That is to say, the material of the heat dissipation piece 47 can be formed with robust heat transmission and heat dissipation according to different actual requirements. The heat dissipation piece 47 is made of metal and includes a pair of protrusions 436 each of which includes a slant guiding surface 437. In assembling, when the heat dissipation piece 47 is inserted into the receiving slot formed between the pair of locking protrusions 432 along a top-to-bottom direction, the heat dissipation piece 47 is outwardly restricted by the pair of locking protrusions 432. Under the guidance of the slant guiding surfaces 437, the protrusions 436 can ultimately pass over the locking protrusions 432 so as to be located below the locking protrusions 432. Once the protrusions 436 pass over the locking protrusions 432, the heat dissipation pieces 47 can be prevented from falling off from the metallic shell 40 along the bottom-to-top direction. When the heat dissipation pieces 47 are ultimately assembled to the side walls 43 in position, they terminate at the supporting portions 433 which upwardly support the heat dissipation pieces 47. The heat dissipation pieces 47 are essentially located outside of the corresponding side walls 43 and are held in the arm by the pair of locking protrusions 432.

It is to be understood, however, that even though numerous, characteristics and advantages of the present invention have been set forth in the foregoing description, together with details of the structure and function of the invention, the disclosed is illustrative only, and changes may be made in detail, especially in matters of number, shape, size, and arrangement of parts within the principles of the invention to the full extent indicated by the broadest general meaning of the terms in which the appended claims are expressed.

What is claimed is:

1. An electrical connector comprising:
an insulative housing comprising a main body and a mating tongue extending forwardly from the main body, the mating tongue defining a mating surface;
a plurality of first contacts retained in the insulative housing, each first contact comprising a resilient first contacting portion upwardly extending beyond the mating surface;
a plurality of second contacts retained in the insulative housing, each second contact comprising a flat second contacting portion exposed to the mating surface, the flat second contacting portions being located at a front of the resilient first contacting portions; and
a metallic shell enclosing the insulative housing and comprising a plurality of peripheral walls, the peripheral walls jointly forming a receiving cavity in which the mating tongue resides; wherein
at least one of the peripheral walls comprises a heat dissipation slot in communication with the receiving cavity and a heat dissipation piece attached to the heat dissipation slot so that heat generated from the first contacts and the second contacts can be transmitted to the heat dissipation piece; and wherein
the heat dissipation piece is separatedly made from the metallic shell and then fixed to the metallic shell.

2. The electrical connector as claimed in claim 1, wherein the heat dissipation piece is made of metal.

3. The electrical connector as claimed in claim 1, wherein the at least one of the peripheral walls comprises a locking member corresponding to the heat dissipation slot, the heat dissipation piece being outwardly restricted by the locking member.

4. The electrical connector as claimed in claim 3, wherein the locking member comprises a pair of locking protrusions which are stamped out from the heat dissipation slot, the heat dissipation piece being inserted between the pair of locking protrusions.

5. The electrical connector as claimed in claim 3, wherein the at least one of the peripheral walls comprises a supporting portion to upwardly support the heat dissipation piece.

6. The electrical connector as claimed in claim 5, wherein the supporting portion extends horizontally and the heat dissipation piece is fixed to the at least one of the peripheral walls along a top-to-bottom direction perpendicular to the supporting portion.

7. The electrical connector as claimed in claim 6, wherein the heat dissipation piece comprises at least one protrusion which is located below the locking member so that the heat dissipation piece can be prevented from falling off from the at least one of the peripheral walls by the locking member.

8. The electrical connector as claimed in claim 7, wherein the at least one protrusion comprises a slant guiding surface for guiding insertion of the heat dissipation piece through the locking member.

9. The electrical connector as claimed in claim 6, wherein the peripheral walls comprise a top wall, a bottom wall and a pair of side walls connecting the top wall and the bottom wall, the supporting portion being located adjacent to and essentially coplanar with the bottom wall.

10. The electrical connector as claimed in claim 9, wherein each side wall is equipped with the heat dissipation piece.

11. The electrical connector as claimed in claim 1, wherein the mating tongue defines a plurality of first slot for mounting the first contacts and a plurality of second slots for mounting the second contacts, each first contact comprising a first retaining portion connecting the first contacting portion and a first soldering portion perpendicularly bent from the first retaining portion, each second contact comprising a second retaining portion parallel to the second contacting portion and a second soldering portion perpendicularly bent from the second retaining portion.

12. The electrical connector as claimed in claim 11, wherein each second slot comprises an upper slot and a lower slot, each second contacting portion comprising a plurality of first barbs engaged within the upper slot for fixation, each second retaining portion comprising a plurality of second barbs engaged with the lower slot for fixation.

13. The electrical connector as claimed in claim 11, wherein the main body of the insulative housing defines a rear cavity and the electrical connector further comprises a contact organizer received in the rear cavity, the contact organizer defining a plurality of first holes and a plurality of second holes through which the first soldering portions and the second soldering portions extend, respectively.

14. The electrical connector as claimed in claim 11, wherein the electrical connector is compatible to USB 3.0 standard.

15. An electrical connector comprising:
an insulative housing comprising a mating tongue defining a mating surface and a plurality of first slots extending through the mating surface;
a plurality of first contacts each comprising a resilient first contacting portion upwardly extending beyond the mating surface, the resilient first contacting portions being deformable in the first slots along a vertical direction;
a plurality of second contacts each comprising a rigid second contacting portion exposed to the mating surface, the rigid second contacting portions being located at a front of the resilient first contacting portions; and
a metallic shell enclosing the insulative housing, the metallic shell comprising a top wall, a bottom wall and a pair of side walls connecting the top wall and the bottom wall, the top wall, the bottom wall and the side walls jointly forming a receiving cavity in which the mating tongue extends; wherein
each side wall is equipped with a metallic heat dissipation member, the heat dissipation members being essentially located outside of the side walls and being assembled to the side walls along the vertical direction.

16. The electrical connector as claimed in claim 15, wherein each side wall comprises a heat dissipation slot in communication with the receiving cavity and a locking member stamped outwardly from the heat dissipation slot, the heat dissipation members being outwardly restricted by the locking members.

17. The electrical connector as claimed in claim 16, wherein each locking member comprises a pair of locking protrusions which hold corresponding heat dissipation member in the arm.

18. The electrical connector as claimed in claim 16, wherein the metallic shell comprises a pair of supporting portions extending adjacent to and essentially coplanar with the bottom wall so as to upwardly support the heat dissipation members.

19. The electrical connector as claimed in claim 16, wherein each heat dissipation member comprises at least one protrusion which is located below the locking member, the at least one protrusion comprising a slant guiding surface for guiding insertion of the heat dissipation member through the locking member.

20. The electrical connector as claimed in claim 15, wherein the electrical connector is compatible to USB 3.0 standard.
